(19) United States
(12) Patent Application Publication
(10) Pub. No.: US 2026/0086805 A1
(43) Pub. Date: Mar. 26, 2026

(54) LOOP DETECTOR AND PREDICTOR

(71) Applicant: Ampere Computing LLC, Santa Clara, CA (US)

(72) Inventors: Michael CHIN, Portland, OR (US); Aaron LINDSAY, Raleigh, NC (US); Bret TOLL, Hillsboro, OR (US)

(21) Appl. No.: 18/891,608

(22) Filed: Sep. 20, 2024

(51) Int. Cl. G06F 9/30; G06F 9/38

(52) U.S. Cl. CPC G06F 9/30065; G06F 9/30058; G06F 9/325; G06F 9/381; G06F 9/3861

(57) ABSTRACT

Disclosed is a branch predictor unit (BPU), comprising a loop predictor configured to predict a repeatedly looping behavior before the repeatedly looping behavior occurs, a loop detector configured to detect the repeatedly looping behavior which is currently occurring, and a loop buffer, configured to treat a plurality of looping operations corresponding to the repeatedly looping behavior as a read-only circular buffer without removing the looping operations from the loop buffer.

### BACKGROUND OF THE DISCLOSURE

### 1. Field of the Disclosure

Aspects of the disclosure relate generally to loop detection and prediction. More specifically, but not exclusively, to loop detection and prediction for enhanced efficiency.

### 2. Description of the Related Art

Branch predictors have been implemented in processors in an attempt to save computing resources and power consumption. Without branch prediction, a processor core would need to wait until each branch instruction has passed the execution stage before the next instruction can enter the fetch stage in the pipeline. A branch predictor may be implemented in the processor core to avoid this waste of time by trying to guess which branch is most likely to be taken, and to which address. The instructions at the guessed branch target may then be fetched and speculatively executed. If it is later detected that the guess was wrong, then the speculatively executed or partially executed instructions are discarded and the pipeline starts over at the correct address, thereby incurring a delay. Despite the possibility of misprediction, however, branch predictors have been implemented in modern pipelined processor architectures to increase the efficiency of processing.

In some situations, some workloads may have regions where the branching behavior is so repetitive that a successful execution only requires continuously replaying the same short sequence of instructions. In such situations, advanced branch prediction and instruction fetch logic typically used in branch predictors may be unneeded and may incur unnecessary power consumption.

In some situations, the front-end of a processor core, including the branch predictor, instruction fetch/cache, and/or instruction decode, for example, may present a performance bottleneck when the back-end of the processor core, including a memory and one or more execution units, for example, could otherwise execute the instructions faster.

Therefore, there is a need for an architecture for predicting and detecting loop behavior to enable execution of loops more efficiently.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, a branch predictor unit (BPU) includes a loop predictor configured to predict a repeatedly looping behavior before the repeatedly looping behavior occurs; a loop detector configured to detect the repeatedly looping behavior which is currently occurring; and a loop buffer, configured to treat a plurality of looping operations corresponding to the repeatedly looping behavior as a read-only circular buffer without removing the looping operations from the loop buffer.

In some aspects, a method performed at a branch predictor unit (BPU) includes predicting a repeatedly looping behavior before the repeatedly looping behavior occurs; detecting the repeatedly looping behavior which is currently occurring; and treating a plurality of looping operations corresponding to the repeatedly looping behavior as a read-only circular buffer without removing the looping operations from a loop buffer.

In some aspects, a branch predictor unit (BPU) includes means for predicting a repeatedly looping behavior before the repeatedly looping behavior occurs; means for detecting the repeatedly looping behavior which is currently occurring; and means for treating a plurality of looping operations corresponding to the repeatedly looping behavior as a read-only circular buffer without removing the looping operations from a loop buffer.

Other objects and advantages associated with the aspects disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure.

FIG. 1 illustrates an example of a processing unit, according to aspects of the disclosure.

FIG. 2 illustrates an example of a processor core which includes a branch predictor unit (BPU), according to aspects of the disclosure.

FIG. 3 illustrates an example of a BPU with loop prediction, according to aspects of disclosure.

FIG. 4 illustrates an example of a loop buffer, according to aspects of the disclosure.

FIG. 5 illustrates an example of a state machine, according to aspects of the disclosure.

FIG. 6 illustrates an example of a branch predictor unit (BPU), according to aspects of the disclosure.

FIG. 7 illustrates a flow chart of a method performed at a BPU, according to aspects of the disclosure.

### DETAILED DESCRIPTION

Other objects and advantages associated with the aspects disclosed herein will be apparent to those skilled in the art based on the accompanying drawings and detailed description. In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

Various aspects of the subject technology relate to processor structures and techniques for improved branch prediction and in some situations, for efficient loop execution by avoiding branch prediction and/or other operations in processor structures.

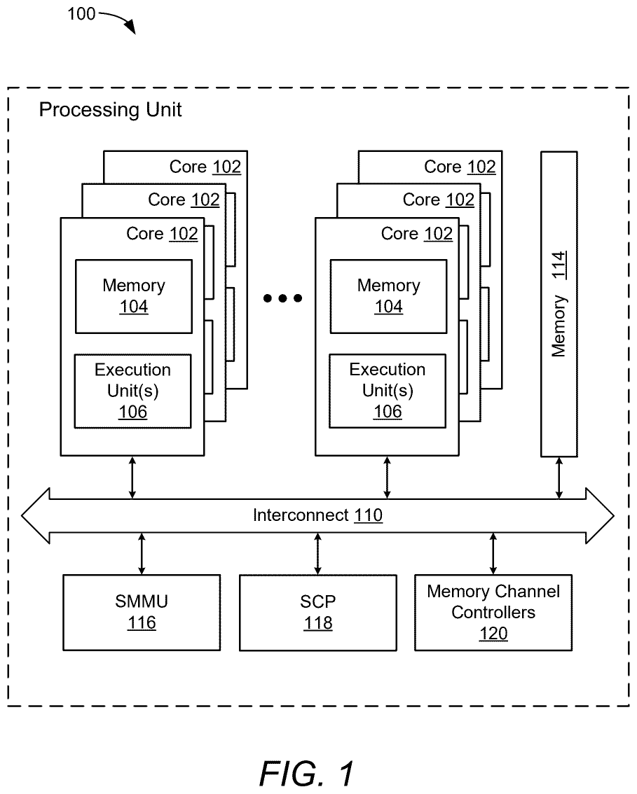

FIG. 1 illustrates an example of a processing unit 100, according to aspects of the disclosure. In some examples, the hardware structures and techniques for branch prediction described herein may be implemented using processing unit 100. Processing unit 100 may be configured as a central processing unit (CPU) but may also be used with or configured as other processing units, such as but not limited to a graphics processing unit (GPU) or tensor processing unit (TPU). Processing unit 100 may include a set of processing cores 102 (or simply “cores” 102). Each core 102 may include memory 104 and one or more execution units 106. Each core 102 may be coupled to interconnect 110, which may be a system on chip (SoC) coherent interconnect. In some examples, memory 104 may be configured as cache on the core 102 (e.g., 16 kB or 64 kB L1 Instruction-cache, 64 kB L1 Data-cache, and 1 MB or 2 MB level 2 (L2) Cache, in some aspects).

The one or more execution units 106 may perform various operations and calculations associated with instructions and micro-operations of the core 102. The one or more execution units 106 may be configured as various units in the core 102 in accordance with various implementations. For example, the one or more execution units 106 may include arithmetic logic units (ALUs) that perform arithmetic and logic operations for the core 102. The one or more execution units 106 may include floating point units (FPUs) that perform floating point calculations. The one or more execution units 106 may include integer execution units (IXUs) for performing integer operations. The one or more execution units 106 may also include single instruction, multiple data (SIMD) execution units for performing various instructions. In some examples, an execution unit 106 may perform a combination of these and other operations. Each of the one or more execution units 106 may include a bus or interconnect, for example, to connect hardware elements of the execution units 106 to memory 104 to perform read and write functions while executing micro-operations. Additionally, or alternatively, one or more execution units 106 including ALUs, FPUs, IXUs, and/or SIMD execution units may be configured for all or a subset of the cores 102.

Processing unit 100 may also include memory 114, which may be coupled to interconnect 110. In some examples, memory 114 may include system-level cache (e.g., 32 MB or 64 MB, in some aspects) that may be used for various purposes by the processing unit 100. Processing unit 100 may also include a system memory management unit (SMMU) 116, The SMMU 116 may provide translation services, for example, to non-processor master units. That is, for example, the SMMU 116 may translate addresses for direct memory address (DMA) requests from system input/output (I/O) devices before the requests are passed to interconnect 110. Processing unit 100 may also include a system control processor (SCP) 118. The SCP 118 may be configured to handle various system management functions. In some examples, the SCP 118 may include separate microcontrollers (or processors). In some examples, the SCP 118 may be combined into one or two microcontrollers, or sub-divided into more than two microcontrollers in accordance with various implementations to handle various system management functions.

Interconnect 110 may be configured as a mesh interconnect that forms a high-speed interface that couples each core 102 to the other cores 102 and other components in processing unit 100. Processing unit 100 may also include memory channel controllers 120 that may be operatively coupled to various memory devices (e.g., external to the processing unit 100). For example, the memory channel controllers 120 may be configured for accessing memory, such as a double data rate (DDR) synchronous dynamic random-access memory (SDRAM) or other memory sources.

It is to be appreciated that the processing unit 100 of FIG. 1 may be configured according to a monolithic die design or a disaggregated chiplet design. That is, for example, in the monolithic die design, the cores 102, interconnect 110, memory 114, SMMU 116, and SCP 118 may be configured on a single die. In some cases, for example, in the disaggregated chiplet design, each chiplet of multiple disaggregated chiplets may include a subset of the cores 102 (e.g., in a tiled fashion) with a memory controller to control a portion of memory 114, and a peripheral component interconnect (PCI) or PCI express (PCIe) controller to control the interface with interconnect 110, SMMU 116, and/or SCP 118. Although FIG. 1 illustrates a processing unit 100 with multiple cores 102, a single core may be provided in some implementations. Additionally, or alternatively, other computer architecture designs may be used in various implementations given the benefit of the disclosure.

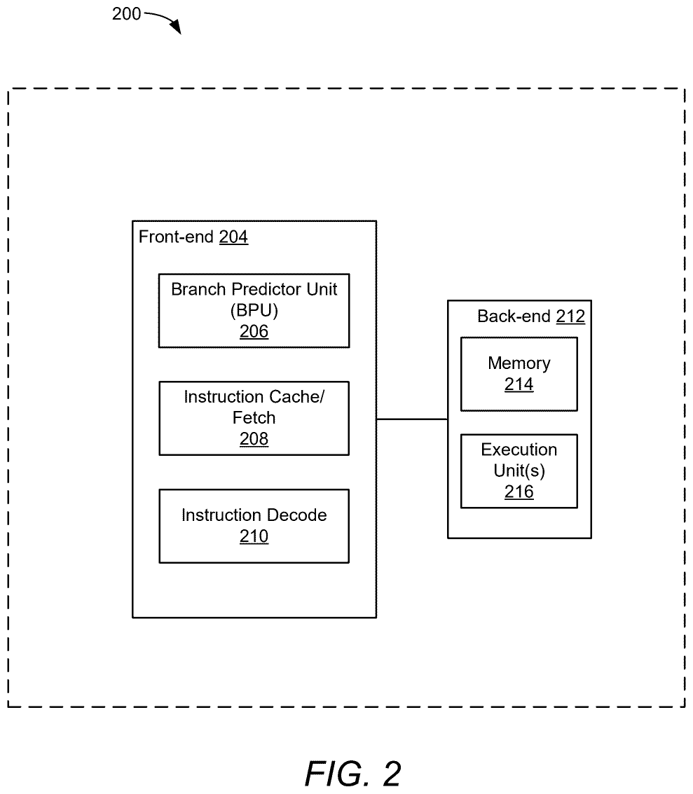

FIG. 2 illustrates an example of a processor 200 which includes a branch predictor unit (BPU), according to aspects of the disclosure. In some aspects, the processor 200 includes a front-end 204, which includes a branch prediction unit (BPU) 206, an instruction cache/fetch 208, an instruction decode 210, and a back-end 212, which includes a memory 214 and one or more execution units 216 for executing code, including, for example, code for performing arithmetic, logic and/or other operations. In some aspects, the processor 200 may include one or more processor cores, for example, processor cores 102 as illustrated in FIG. 1.

In some aspects, the front-end 204 may perform fetching of instructions, albeit sometimes by way of other caches and/or external memory. In some situations, upon a flush (i.e. a branch misprediction), the back-end 212 may sometimes send an instruction address to the front-end 204 to instruct it where to restart an instruction fetch, although the back-end 212 typically may not send actual instructions to the front end 204. In some aspects, the BPU 206 in the front-end 204 is configured to predict branch behavior (e.g., an if-then-else conditional structure) before it is known definitively. In some aspects, the purpose of the BPU is to improve the flow in the instruction pipeline, thus improving the performance of processing in pipelined processor architectures.

In some aspects, because branch prediction may be an iterative or staged process, it may sometimes or frequently be the case that instruction fetch and decode (and in some cases, execution) may occur concurrently with prediction and not strictly after it. For example, in some instances, the BPU 206 may make an early prediction, thus allowing instruction fetch to begin. In some instances, instructions may be later cleared (i.e., canceled) if a later, more accurate branch prediction differs from an earlier prediction by the BPU 206. In some aspects, branching by a BPU may be implemented with various types of branches, including direct branches (e.g., conditional branches) and indirect branches (e.g., where branch target addresses are stored in a register value and not apparent from the instruction encoding itself). For example, the BPU 206 may detect and predict a direct branch with a conditional jump instruction. In some aspects, a conditional jump may either be “taken” and jump to a different place in program memory, or may be “not taken” and continue execution immediately after the conditional jump. In general, it is not known for certain whether a conditional jump will be “taken” or “not taken” until the condition has been calculated and the conditional jump has passed the execution stage in the instruction pipeline (e.g., by the execution units 216 in FIG. 2). In some aspects, the BPU 206 may also predict unconditional branches, including indirect branches.

In some aspects, the BPU 206 described herein may reside in one or more blocks of the processing unit 100 of FIG. 1. For example, the BPU 206 may reside in one or more of the cores 102 in the processing unit 100 which is shown as a multicore processor. In an single-core processor, the BPU 206 may reside in the single processing core. In some aspects, the BPU 206 may reside in a front-end 204 (not shown in FIG. 1) of a core 102 where instructions are fetched before they are sent to an execution unit 106.

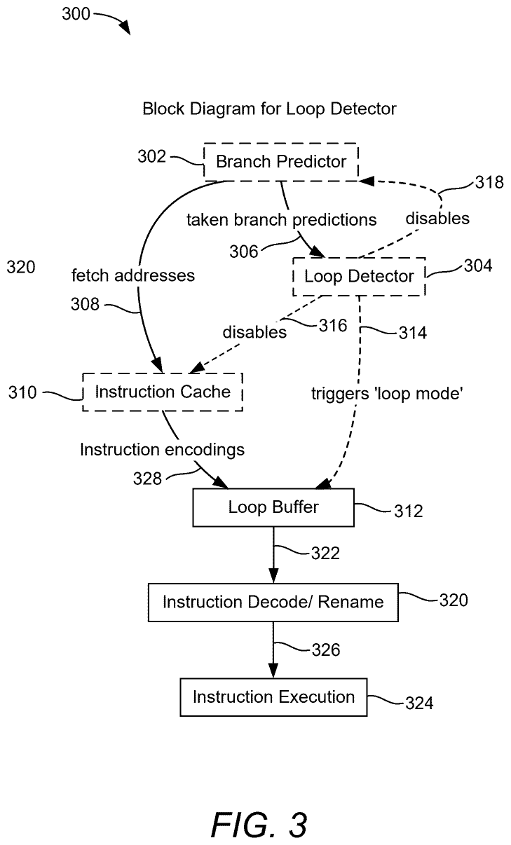

FIG. 3 illustrates an example of a BPU 300 with loop prediction, according to aspects of disclosure. For the purpose of illustration, the components in dashed boxes in FIG. 3 are disabled when the BPU 300 is in a loop mode, during which time the looped instructions are kept in an instruction queue (IQ) or another type of loop buffer, and the same instructions are repeatedly sent to the back-end of the processor core for decoding, renaming, and/or execution, for example. Also for the purpose of illustration, the dashed arrows in FIG. 3 illustrate operations taken when the BPU 300 enters loop mode.

In the example illustrated in FIG. 3, the BPU 300 includes a branch predictor 302 which may make predictions of “taken” branches and send the “taken” branch predictions to a loop detector 304, as indicated by solid arrow 306. In some aspects, the branch predictor 302 may send fetch addresses as indicated by solid arrow 308 to an instruction cache 310 when the BPU 300 is not in a loop mode.

In some aspects, the loop detector 304 may make a loop detection and trigger a loop mode upon detecting that an execution is repeatedly looping. Upon activation of the loop mode, the loop detector 304 may signal to a loop buffer 312 (e.g., an instruction queue (IQ)) that the repeatedly looping instructions are not removed from the loop buffer 312 when decoded and executed, as indicated by dashed arrow 314. Instead of being removed from the loop buffer upon decode/execution as they might be during normal operation, the loop buffer is treated as a read-only circular buffer and the same set of instructions is repeatedly read out of the loop buffer, in order, and fed to decode/execution. Because the same instructions are able to be re-used, this eliminates the need for the majority of the traditional branch prediction and instruction fetch structures and logic. For example, the loop detector 304 may recognize that an execution is repeatedly looping when it determines that at least a threshold number of branches'worth of branch history match between two consecutive samples taken when predicting the same branch.

In some aspects, upon activation of the loop mode, the loop detector 304 may disable the instruction cache 310, as indicated by dashed arrow 316. In some aspects, upon activation of the loop mode, the loop detector 304 may disable the branch predictor 302, as indicated by dashed arrow 318. In some aspects, the loop detector 304 itself may be disabled while the BPU 300 is in a loop mode. By disabling or powering down the branch predictor 302, the loop detector 304, and/or the instruction cache 310 while the BPU 300 is in a loop mode, power savings may be achieved.

In some aspects, while the BPU 300 is in a loop mode, the repeatedly looping instructions may be maintained in the loop buffer 312 or another type of loop buffer, and the same instructions may be repeatedly sent to the back-end of the processor core for further processing. For example, in the example illustrated in FIG. 3, the loop buffer 312 may send these instructions to instruction decode/rename 320 as indicated by solid arrow 322, and to instruction execution 324 as indicated by solid arrow 326.

In some aspects, when the BPU 300 is not in a loop mode, the instruction cache 310 may send instruction encodings to the loop buffer 312, as indicated by solid arrow 328. The loop buffer 312 may send non-looping instructions to instruction decode/rename 320 as indicated by solid arrow 322, and to instruction execution 324 as indicated by solid arrow 326.

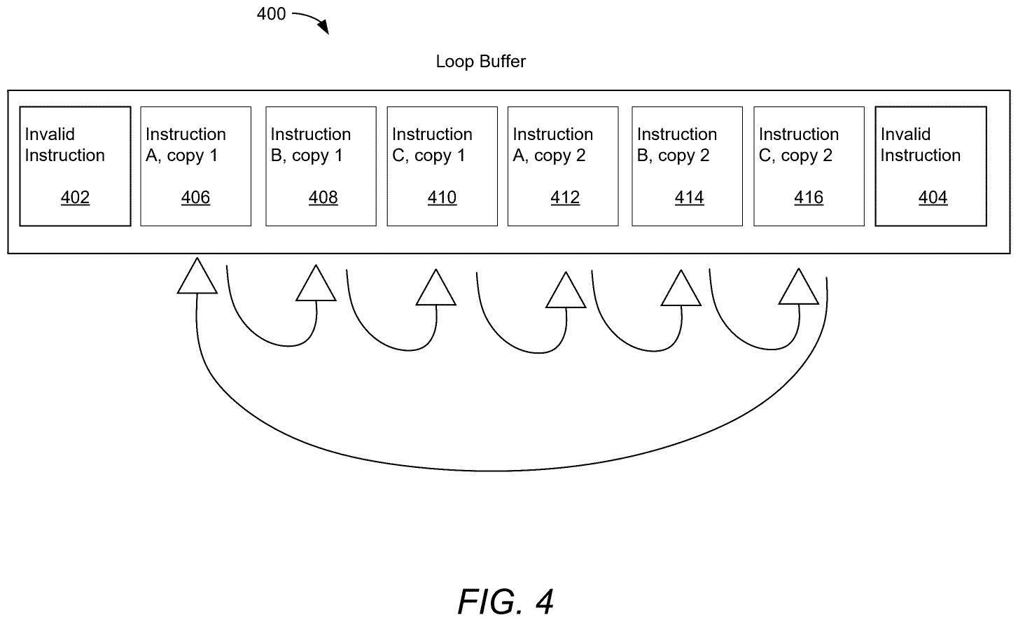

FIG. 4 illustrates an example of a loop buffer 400, according to aspects of the disclosure. In some aspects, the loop buffer 400 as shown in FIG. 4 may be the loop buffer 312 in the BPU 300 of FIG. 3. In some aspects, the loop buffer may be an IQ. In some aspects, FIG. 4 illustrates an example of the order or flow of instructions sent from the loop buffer 400 to be executed while the front-end is in a loop mode. In a normal operation (that is, when the front-end is not in a loop mode), an instruction may be removed once it is sent for execution and is not sent again. While the front-end is in a loop mode, however, the repeatedly looping instructions may remain in the loop buffer and are repeatedly sent for execution until the front-end exits the loop mode.

In some aspects, invalid instructions, such as invalid instructions 402 and 404 in the loop buffer 400 as shown in FIG. 4, are not sent. In the example shown in FIG. 4, the loop buffer 400 stores two copies of each of three instructions, including Instruction A, copy 1 (denoted as block 406), Instruction B, copy 1 (denoted as block 408), Instruction C, copy 1 (denoted as block 410), Instruction A, copy 2 (denoted as block 412), Instruction B, copy 2 (denoted as block 414), and Instruction C, copy 2 (denoted as block 416). While the front-end is in a loop mode, these instructions and their copies may remain in the loop buffer 400 and may be repeatedly sent for execution.

In some aspects, two or more copies of the same set of instructions may be installed in the loop buffer 400, as illustrated in FIG. 4. In some aspects, multiple copies of the same instruction (e.g., instruction with a short loop) may be installed for “loop unrolling,” described in further detailed below, such that instructions with short loops may not need to wrap around more than once in a single cycle when fetching them out.

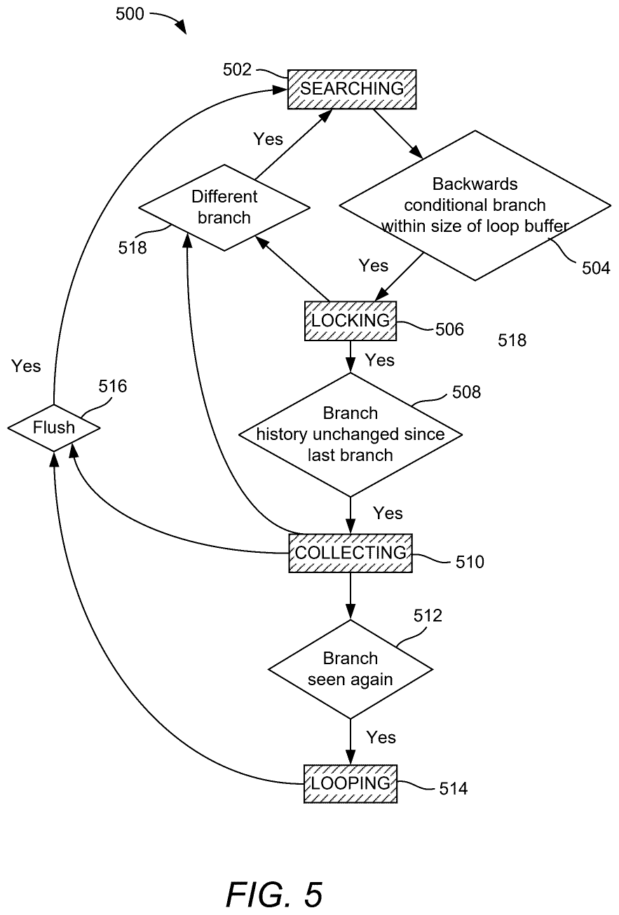

FIG. 5 illustrates an example of a state machine 500, according to aspects of the disclosure. In some aspects, searching (denoted as block 502) is performed on a branch and a determination is made as to whether it is a backwards conditional branch within the size of the loop buffer (denoted as block 504). If the backward conditional branch is within the size of the loop buffer, then the loop detector enters the locking state (denoted as block 506). If the backward conditional branch is not within the size of the loop buffer, then the relevant state transition does not occur and the loop detection state machine remains in the previous state.

If the branch history is unchanged since the last branch (denoted as block 508), then the front-end begins collecting the instructions inside the loop into the loop buffer, or other loop buffer (denoted as block 510). If the branch history is changed since the last branch, then the relevant state transition does not occur and the loop detection state machine remains in the previous state. A determination is made as to whether the same branch is seen again (denoted as block 512). If the same branch is seen again, then the BPU begins looping over the collected instructions (denoted as block 514). If the same branch is not seen again, then the relevant state transition does not occur and the loop detection state machine remains in the previous state.

In some aspects, a determination is made as to whether there is a flush (denoted as block 516) before, during, or after collecting (denoted as block 510) and/or looping (denoted as block 514). In some aspects, a flush may indicate a branch misprediction. After a flush is detected (denoted as block 516), a new search (denoted as block 502) may be performed on a different branch (denoted as block 518). If a flush is not detected, then the relevant state transition does not occur and the loop detection state machine remains in the previous state. In some aspects, a determination may be made as to whether a new branch is a different branch (denoted as block 518) after locking (denoted as block 506) and/or collecting (denoted as block 510). If a different branch is seen, then the searching process (denoted as block 502) starts again. If no different branch is seen, then the relevant state transition does not occur and the loop detection state machine remains in the previous state.

The high-level state machine for Loop Detection, where “SEARCHING” is the beginning of the process, and “LOOPING” represents that the Branch Prediction Unit, instruction fetch, and/or other front-end operations are disabled and the loop buffer (in our case, the Instruction Queue) is solely responsible for supplying instructions for the back-end to execute.

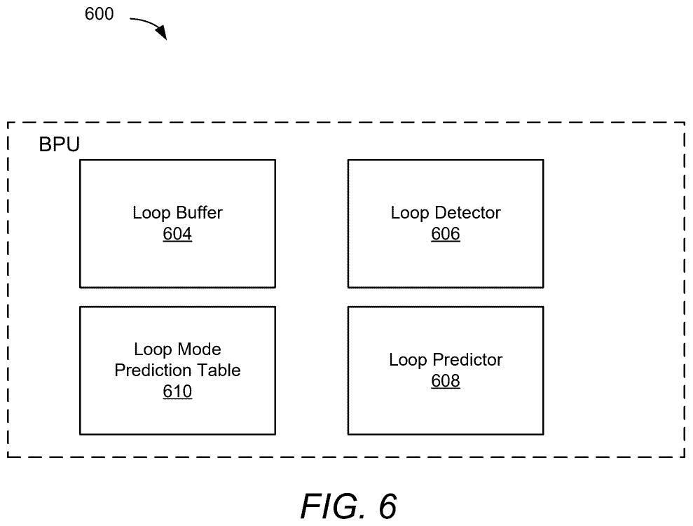

FIG. 6 illustrates an example of a BPU 600, according to aspects of the disclosure. In some aspects, FIG. 6 is a simplified block diagram illustrating the relationship between a loop buffer 604 (e.g., an instruction queue (IQ)), a loop detector 606 and a loop predictor 608. In some aspects, the loop predictor 608 may be configured to predict a repeatedly looping behavior before the repeatedly looping behavior occurs. In some aspects, the loop detector 606 may be configured to detect the repeatedly looping behavior when the repeatedly looping behavior is currently occurring. In some aspects, the loop buffer 604 may be configured to treat a plurality of looping operations corresponding to the repeatedly looping behavior as a read-only circular buffer without removing the looping operations from the loop buffer.

In some aspects, the loop detector 606 may be further configured to determine that the repeatedly looping behavior has been occurring by recording a branch history when a branch that is potentially part of a loop is detected, and checking whether one or more next instances of the branch have a branch history matching at least a threshold number of branches of a previous recorded branch history, and determine that the loop has a length suitable for storage in the loop buffer.

In some aspects, the repeatedly looping behavior may be defined by repeatedly looping executions. In some aspects, the loop predictor 608 may be further configured to determine whether the repeatedly looping executions have a duration of looping behavior longer than a threshold duration, track a duration of each instance of the repeatedly looping executions, record a branch history corresponding to a loop entrance of the repeatedly looping executions that have a duration of looping behavior longer than the threshold duration, and count a number of repeatedly looping executions that have a duration of looping behavior longer than the threshold duration.

In some aspects, the loop predictor 608 may be configured to train a loop mode prediction table having a plurality of desirable entries that are used to determine whether to enter a loop mode based at least in part on the branch history and the number of the repeatedly looping executions.

In some aspects, the loop predictor 608 may be configured to enter the loop mode based on a determination that the branch history of a current branch matches at least one of the desirable entries in the loop mode prediction table.

In some aspects, the loop buffer 604 may be configured to exit the loop mode upon receiving a flush. In some aspects, a branch misprediction may cause the flush. In some aspects, copies of looping operations that have a loop duration shorter than a threshold duration may be installed in the loop buffer.

In some aspects, the loop detector 606 may be configured to determine whether a first branch tracked by the loop detector having a first branch program counter (PC) is not detected again with a branch history that matches a prior instance of an operation having a sufficient branch history depth within a period of time or a number of predictions, stop tracking the first branch based on a determination that the first branch tracked by the loop detector having the first branch PC is not detected again with a branch history that matches the prior instance to a sufficient depth, and start tracking a second branch having a second branch PC.

In some aspects, the loop detector 606 or the loop predictor 608, either alone or in combination, may be further configured to determine a number of branch mispredictions and disable a loop prediction or a loop detection based on the number of branch mispredictions.

In some aspects, the loop prediction or the loop detection may be disabled for a number of cycles or a number of predictions.

In some aspects, by increasing the confidence that the branch is entering a loop in which it is likely to be in for at least a given period of time or at least a given number of repetitions (e.g., already been looping for a while, or having seen a long-enough loop beginning at the branch history in the recent past), it is possible to avoid the more complex (and expensive) task of predicting loop exit. In some aspects, the BPU 206 may simply exit the loop mode the next time the front-end 204 receives a flush (e.g., typically a branch misprediction).

In some aspects, a single copy of the loop's dynamic instruction stream may be installed in the loop buffer while in the loop mode. In some cases, however, installing a single copy may be sub-optimal (e.g., if the microarchitecture is unable to read instructions out as fast as desired due to not being efficient to wrap-around multiple times in the same cycle). In some aspects, multiple copies of short loops may be installed in the loop buffer 604 such that the instructions may not need to wrap around more than once in a single cycle when fetching them out. In some aspects, such a scheme of installing multiple copies of instructions with short loops may be referred to as loop unrolling. In some aspects, this may cost one or more extra iterations of the front-end being fully enabled prior to entering the loop mode, but may result in a beneficial tradeoff which makes up for the extra entrance cost with increased processing performance.

In some aspects, a simple way to detect loops using branch history may include sampling the branch history when predicting a branch at a given PC, and watching for the same branch history at the same PC before more dynamic instructions than those that will fit in the loop buffer 604 (e.g., IQ) are detected. In some cases, however, the same branch may be taken multiple times in some looping behavior (e.g., an inner loop taken twice each time inside an outer loop repeatedly taken). In such cases, if the BPU 600 monitors only one branch PC and that PC is the “wrong” one, a well-formed loop may not be detected.

In some aspects, to avoid the likelihood of tracking a single “wrong” branch PC, the BPU 600 may periodically stop tracking a branch if it has not found the same branch history, and instead, start tracking another branch PC. If this is done carefully (e.g., stop tracking a branch if the same branch is found with a different history even if the number of instructions which will fit in the loop buffer has not been exceeded), the branch instructions may be cycled through in a potential loop to ensure that the BPU 600 is not always monitoring the “wrong” (i.e., non-loop) branch.

In some aspects, if the BPU 600 periodically stops tracking a branch, it may pick up on more complex looping behavior while still only tracking a single branch PC at a time, thus avoiding the cost of power consumption required for larger tracking arrays.

In some aspects, a “circuit breaker” (i.e., disabling the loop mode for some configurable lockout period) may be implemented in situations where loop detection and prediction have become “pathological” (e.g., in situations where the BPU 600 continually enters the loop mode immediately prior to the end of the loop).

In some aspects, the BPU 600 may detect a condition when the loop mode is having a negative performance impact for a particular workload, and in response to that condition, activate the “circuit breaker” by disabling the loop mode for a configurable lockout period (e.g., based on the number of cycles or the number of predictions made). In some aspects, the BPU 600 may activate the “circuit breaker” based on the number of recent branch mispredictions being too high, either on its own, or relative to the number of times the loop mode has been entered, for example.

In some aspects, because the BPU 600 may rely on a consistent branch history register for consistency, it may be expected that the BPU 600 will continue updating the branch history during the loop mode. In some situations, however, continuous updating of branch history may require a nontrivial expenditure of power and add undesirable complexity and timing cost to other critical areas of the processor 200.

In some aspects, as long as there is consistency with respect to updating the branch history with a taken branch if and only if it is predicted while the BPU 600 is not in the loop mode, the branch history is expected to remain consistent enough to not negatively impact the performance of the processor 200 via the introduction of significant numbers of additional branch mispredictions.

In some aspects, if a given loop enters the loop mode frequently, for example, the loop detector 606 may train branches following that loop using a new branch history. In some aspects, the new branch history may have a “hole” for the loop-mode portion of execution. Additionally, because this “hole” may typically have been mostly “uninteresting” branches since they were mostly the same, omitting this part of branch history may allow the branch history to become effectively longer, which may further improve branch prediction in some cases.

As will be appreciated, a technical advantage of the BPU 600 is that, by implementing the loop detector 606 according to the aspects of the disclosure, power consumption by the processor 200 may be intelligently reduced by nearly entirely disabling the front-end 204 of the processor 200 while the BPU is in certain types of loop mode situations without negatively impacting performance. In some aspects, the processor 200 may achieve a higher level of power efficiency without sacrificing performance, and in some cases, with improved performance. In some aspects, a power-efficient front-end design may be achieved without requiring large tracking arrays, thus minimizing the additional power and complexity that otherwise would be needed to improve the processing performance of the processor 200.

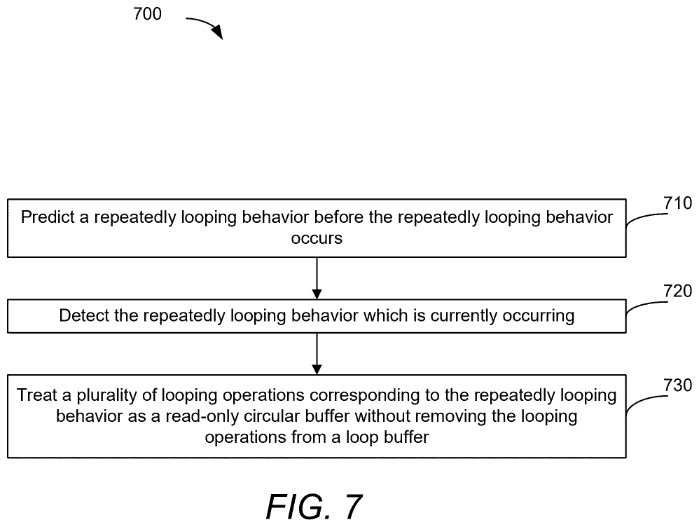

FIG. 7 illustrates a flow chart of a method 700 performed at a BPU, such as the BPU 600, in accordance with aspects of the disclosure. In some implementations, one or more process blocks of FIG. 7 may be performed by a BPU (e.g., BPU 206, 600). In some implementations, one or more process blocks of FIG. 7 may be performed by another device or a group of devices separate from or including the BPU. Additionally, or alternatively, one or more process blocks of FIG. 7 may be performed by one or more components of one or more processors, any or all of which may be means for performing the operations of method 700.

As shown in FIG. 7, method 700 may include, at operation 710, predicting a repeatedly looping behavior before the repeatedly looping behavior occurs. Means for performing operation 710 may include any of the apparatuses described herein.

As further shown in FIG. 7, method 700 may include, at operation 720, detecting the repeatedly looping behavior which is currently occurring. Means for performing operation 720 may include any of the apparatuses described herein. For example, the BPU 600 may detect a plurality of repeatedly looping executions in the buffer 604, using the loop detector 606.

As further shown in FIG. 7, method 700 may include, at operation 730, treating a plurality of looping operations corresponding to the repeatedly looping behavior as a read-only circular buffer without removing the looping operations from a loop buffer. Means for performing operation 730 may include any of the apparatuses described herein. For example, the BPU 600 may activate a loop mode upon detecting the repeatedly looping executions in the buffer 604, using the loop detector 606.

Method 700 may include additional implementations, such as any single implementation or any combination of implementations described below and/or in connection with one or more other processes described elsewhere herein.

In some aspects, method 700 includes determining that the repeatedly looping behavior has been occurring by recording a new branch history when a branch that is likely part of a loop is detected, and monitoring the branch with the new branch history that matches at least a threshold number of branches of an existing branch history, and determining that the loop has a length suitable for storage in the loop buffer.

In some aspects, the repeatedly looping behavior is defined by a plurality of repeatedly looping executions, further comprising determining whether the repeatedly looping executions have a duration of looping behavior longer than a threshold duration, tracking the repeatedly looping executions that have a duration of looping behavior longer than the threshold duration, recording a branch history corresponding to a loop entrance of the repeatedly looping executions that have a duration of looping behavior longer than the threshold duration, and counting a number of repeatedly looping executions that have a duration of looping behavior longer than the threshold duration.

In some aspects, method 700 includes training a loop mode prediction table having a plurality of desirable entries that are used to determine whether to enter a loop mode based at least in part on the branch history and the number of the repeatedly looping executions.

In some aspects, method 700 includes entering the loop mode based on a determination that the branch history of a current branch matches at least one of the desirable entries in the loop mode prediction table.

Although FIG. 7 shows example blocks of method 700, in some implementations, method 700 may include additional blocks, fewer blocks, different blocks, or differently arranged blocks than those depicted in FIG. 7. Additionally, or alternatively, two or more of the blocks of method 700 may be performed in parallel, or performed in a sequence different from the sequence listed in FIG. 7. In one or more example aspects, the functions described may be implemented in hardware, software, firmware, or any combination thereof.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended. Furthermore, it is also intended that aspects of a clause can be included in any other independent clause, even if the clause is not directly dependent on the independent clause.

Any reference herein to an element using a designation such as “first,” “second,” and so forth does not limit the quantity and/or order of those elements. Rather, these designations are used as a convenient method of distinguishing between two or more elements and/or instances of an element. Also, unless stated otherwise, a set of elements can comprise one or more elements.

Aspects of the present disclosure are illustrated in the description and related drawings directed to specific embodiments. Alternate aspects or embodiments may be devised without departing from the scope of the teachings herein. Additionally, well-known elements of the illustrative embodiments herein may not be described in detail or may be omitted so as not to obscure the relevant details of the teachings in the present disclosure.

The word “exemplary” is used herein to mean “serving as an example, instance, or illustration.” Any details described herein as “exemplary” is not to be construed as advantageous over other examples. Likewise, the term “examples” does not mean that all examples include the discussed feature, advantage or mode of operation. Furthermore, a particular feature and/or structure can be combined with one or more other features and/or structures. Moreover, at least a portion of the apparatus described herein can be configured to perform at least a portion of a method described herein.

In certain described example implementations, instances are identified where various component structures and portions of operations can be taken from known, conventional techniques, and then arranged in accordance with one or more exemplary embodiments. In such instances, internal details of the known, conventional component structures and/or portions of operations may be omitted to help avoid potential obfuscation of the concepts illustrated in the illustrative embodiments disclosed herein.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Various components as described herein may be implemented as application specific integrated circuits (ASICs), programmable gate arrays (e.g., FPGAs), firmware, hardware, software, or a combination thereof. Further, various aspects and/or embodiments may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to”, “instructions that when executed perform”, “computer instructions to” and/or other structural components configured to perform the described action.

Those of skill in the art further appreciate that the various illustrative logical blocks, components, agents, IPs, modules, circuits, and algorithms described in connection with the aspects disclosed herein may be implemented as electronic hardware, instructions stored in memory or in another computer readable medium and executed by a processor or other processing device, or combinations of both. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, processors, controllers, components, agents, IPs, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Nothing stated or illustrated depicted in this application is intended to dedicate any component, action, feature, benefit, advantage, or equivalent to the public, regardless of whether the component, action, feature, benefit, advantage, or the equivalent is recited in the claims.

In the detailed description above it can be seen that different features are grouped together in examples. This manner of disclosure should not be understood as an intention that the claimed examples have more features than are explicitly mentioned in the respective claim. Rather, the disclosure may include fewer than all features of an individual example disclosed. Therefore, the following claims should hereby be deemed to be incorporated in the description, wherein each claim by itself can stand as a separate example. Although each claim by itself can stand as a separate example, it should be noted that-although a dependent claim can refer in the claims to a specific combination with one or one or more claims-other examples can also encompass or include a combination of said dependent claim with the subject matter of any other dependent claim or a combination of any feature with other dependent and independent claims. Such combinations are proposed herein, unless it is explicitly expressed that a specific combination is not intended. Furthermore, it is also intended that features of a claim can be included in any other independent claim, even if said claim is not directly dependent on the independent claim.

It should furthermore be noted that methods, systems, and apparatus disclosed in the description or in the claims can be implemented by a device comprising means for performing the respective actions and/or functionalities of the methods disclosed.

Furthermore, in some examples, an individual action can be subdivided into one or more sub-actions or contain one or more sub-actions. Such sub-actions can be contained in the disclosure of the individual action and be part of the disclosure of the individual action.

While the foregoing disclosure shows illustrative examples of the disclosure, it should be noted that various changes and modifications could be made herein without departing from the scope of the disclosure as defined by the appended claims. The functions and/or actions of the method claims in accordance with the examples of the disclosure described herein need not be performed in any particular order. Additionally, well-known elements will not be described in detail or may be omitted so as to not obscure the relevant details of the aspects and examples disclosed herein. Furthermore, although elements of the disclosure may be described or claimed in the singular, the plural is contemplated unless limitation to the singular is explicitly stated.

1. A branch predictor unit (BPU), comprising:
a loop predictor configured to predict a repeatedly looping behavior before the repeatedly looping behavior occurs;
a loop detector configured to detect the repeatedly looping behavior which is currently occurring; and
a loop buffer, configured to treat a plurality of looping operations corresponding to the repeatedly looping behavior as a read-only circular buffer without removing the looping operations from the loop buffer, wherein a same set of instructions is repeatedly read out of the read-only circular loop buffer.

2. The BPU of claim 1, wherein the loop detector is further configured to:
determine that the repeatedly looping behavior has been occurring by recording a branch history when a branch that is potentially part of a loop is detected, and checking whether one or more next instances of the branch have a branch history matching at least a threshold number of branches of a previous recorded branch history; and
determine that the loop has a length suitable for storage in the loop buffer.

3. The BPU of claim 1, wherein the repeatedly looping behavior is defined by a plurality of repeatedly looping executions, wherein the loop predictor is further configured to:
determine whether the repeatedly looping executions have a duration of looping behavior longer than a threshold duration;
track a duration of each instance of the repeatedly looping executions;
record a branch history corresponding to a loop entrance of the repeatedly looping executions that have a duration of looping behavior longer than the threshold duration; and
count a number of repeatedly looping executions that have a duration of looping behavior longer than the threshold duration.

4. The BPU of claim 3, wherein the loop predictor is further configured to train a loop mode prediction table having a plurality of desirable entries that are used to determine whether to enter a loop mode based at least in part on the branch history and the number of the repeatedly looping executions.

5. The BPU of claim 4, wherein the loop predictor is further configured to enter the loop mode based on a determination that the branch history of a current branch matches at least one of the desirable entries in the loop mode prediction table.

6. The BPU of claim 5, wherein the loop buffer is further configured to exit the loop mode upon receiving a flush.

7. The BPU of claim 6, wherein a branch misprediction causes the flush.

8. The BPU of claim 3, wherein a plurality of copies of looping operations that have a loop duration shorter than a threshold duration are installed in the loop buffer.

9. The BPU of claim 1, wherein the loop detector is further configured to:
determine whether a first branch tracked by the loop detector having a first branch program counter (PC) is not detected again with a branch history that matches a prior instance of an operation having a sufficient branch history depth within a period of time or a number of predictions;
stop tracking the first branch based on a determination that the first branch tracked by the loop detector having the first branch PC is not detected again with a branch history that matches the prior instance to a sufficient depth; and
start tracking a second branch having a second branch PC.

10. The BPU of claim 1, wherein the loop detector or the loop predictor, either alone or in combination, is further configured to:
determine a number of branch mispredictions; and
disable a loop prediction or a loop detection based on the number of branch mispredictions.

11. The BPU of claim 10, wherein the loop prediction or the loop detection is disabled for a number of cycles or a number of predictions.

12. A method performed at a branch predictor unit (BPU), the method comprising:
predicting a repeatedly looping behavior before the repeatedly looping behavior occurs;
detecting the repeatedly looping behavior which is currently occurring; and
treating a plurality of looping operations corresponding to the repeatedly looping behavior as a read-only circular buffer without removing the looping operations from a loop buffer, wherein a same set of instructions is repeatedly read out of the read-only circular loop buffer.

13. The method of claim 12, further comprising:
determining that the repeatedly looping behavior has been occurring by recording a current branch history when a branch that is potentially part of a loop is detected, and checking whether one or more next instances of the branch have a branch history matching at least a threshold number of branches of the current branch history; and
determining that the loop has a length suitable for storage in the loop buffer.

14. The method of claim 12, wherein the repeatedly looping behavior is defined by a plurality of repeatedly looping executions, further comprising:
determining whether the repeatedly looping executions have a duration of looping behavior longer than a threshold duration;
tracking a duration of each instance of the repeatedly looping executions;
recording a branch history corresponding to a loop entrance of the repeatedly looping executions that have a duration of looping behavior longer than the threshold duration; and
counting a number of repeatedly looping executions that have a duration of looping behavior longer than the threshold duration.

15. The method of claim 14, further comprising:
training a loop mode prediction table having a plurality of desirable entries that are used to determine whether to enter a loop mode based at least in part on the branch history and the number of the repeatedly looping executions.

16. The method of claim 15, further comprising:
entering the loop mode based on a determination that the branch history of a current branch matches at least one of the desirable entries in the loop mode prediction table.

17. A branch predictor unit (BPU), comprising:
means for predicting a repeatedly looping behavior before the repeatedly looping behavior occurs;
means for detecting the repeatedly looping behavior which is currently occurring; and
means for treating a plurality of looping operations corresponding to the repeatedly looping behavior as a read-only circular buffer without removing the looping operations from a loop buffer, wherein a same set of instructions is repeatedly read out of the read-only circular loop buffer.

18. The BPU of claim 17, further comprising:
means for determining that the repeatedly looping behavior has been occurring by recording a current branch history when a branch that is potentially part of a loop is detected, and checking whether one or more next instances of the branch have a branch history matching at least a threshold number of branches of the current branch history; and
means for determining that the loop has a length suitable for storage in the loop buffer.

19. The BPU of claim 17, wherein the repeatedly looping behavior is defined by a plurality of repeatedly looping executions, further comprising:
means for determining whether the repeatedly looping executions have a duration of looping behavior longer than a threshold duration;
means for tracking a duration of each instance of the repeatedly looping executions;
means for recording a branch history corresponding to a loop entrance of the repeatedly looping executions that have a duration of looping behavior longer than the threshold duration; and
means for counting a number of repeatedly looping executions that have a duration of looping behavior longer than the threshold duration.

20. The BPU of claim 19, further comprising:
means for training a loop mode prediction table having a plurality of desirable entries that are used to determine whether to enter a loop mode based at least in part on the branch history and the number of the repeatedly looping executions.
